(19) United States
(12) Patent Application Publication
(10) Pub. No.: US 2008/0085234 A1
(43) Pub. Date: Apr. 10, 2008

(54) Chemical separation method for fullerenes

(75) Inventors: Janice Paige Phillips, Hattiesburg, MS (US); Bryan Koene, Blacksburg, VA (US); Stephen Ross Wilson, Danville, VA (US)

Correspondence Address: BUCHANAN, INGERSOLL & ROONEY PC, POST OFFICE BOX 1404, ALEXANDRIA, VA, 22313-1404, US

(73) Assignee: LUNA INNOVATIONS, Blacksburg, VA (US)

(21) Appl. No.: 11/322,233

(22) Filed: Jan. 3, 2006

Related U.S. Application Data
(60) Provisional application No. 60/640,234, filed on Jan. 3, 2005.

(51) Int. Cl. C01B 31/02; C01B 31/00

(52) U.S. Cl. 423/461; 423/414

(57) ABSTRACT

A method for separating two types of fullerene molecules in a mixture can comprise: contacting a mixture comprising different fullerenes with a reagent that reacts at different rates or to a different extent with different types of fullerenes in the mixture and separating the fullerenes based upon the extent of reaction between the fullerene and the reagent.

### PRIOR APPLICATION

This application claims the benefit of U.S. Provisional Application No. 60/640,234, filed on Jan. 3, 2005, the entire contents of which are hereby incorporated herein by reference in their entirety.

### GOVERNMENT SUPPORT

Work described herein was supported by the NSF under Grant #DMI-0232204, Grant # DMI-0321630, and Grant #DMI-0349691. The U.S. Government may have certain rights in the invention.

### BACKGROUND OF THE INVENTION

1. Field of the Invention

The invention relates to methods of separating and/or purifying fullerenes.

2. Description of the Related Art

Typical methods of producing specific forms of fullerene include a multi-step process with costs associated with production, separation and purification of materials. Electric-arc synthesis of fullerenes was developed by Kratschmer and Huffman in 1990. (Kratschmer et al., Nature, 347:354, 1990). The “batch production method” typically involves evaporating graphite electrodes in a helium atmosphere at approximately 100 torr. Graphite electrode rods are brought into proximity with sufficient voltage applied that an arc is struck, creating a plasma. As the graphite is consumed, rods can be fed into the chamber through a sliding seal. Typically, after one or two rods have been vaporized, the chamber is opened, and a batch of condensed soot is removed for subsequent solvent extraction. The soot contains a mixture of fullerenes Cₘ where m gives the number of carbons. Generally, m is an even number usually between 60 and 200.

Endohedral metallofullerenes can be created in a mixture with classical empty fullerenes by adding impurities such as metal oxide powder to the graphite rods. “Endohedral metallofullerenes” refers to the encapsulation of atoms inside a fullerene cage network. Methods of making endohedral metallofullerenes have been previously described, for example, in U.S. Pat. No. 6,303,760.

A type of endohedral metallofullerenes, trimetallic nitride endohedral metallofullerenes, exemplified by Trimetaspheres produced by Luna Innovations, can be represented generally as A₃₋ₙXₙN@Cₘ; where A and X are metal atoms, n=0-3, and m can have even values between about 60 and about 200. All elements to the right of the “@” symbol are part of the fullerene cage network, while all elements listed to the left are contained within the fullerene cage network. As an example, Sc₃N@C₈₀ indicates that a Sc₃N trimetallic nitride is situated within a C₈₀ fullerene cage.

In a typical production method, soot produced from the vaporization of the graphite electrodes in the reactor is extracted using solvents to separate fullerenes from amorphous carbon. Protocols for further purification typically rely heavily on high-pressure liquid chromatography (HPLC). These methods generally require, for example, costly fullerene-binding columns, large volumes of aromatic organic solvent, and significant labor.

### SUMMARY

In various embodiments, methods described herein provide for separation of different types of fullerenes and/or for the purification of selected types fullerenes from various contaminants using chemical and/or electrochemical reactions.

For example, a method for separating two types of fullerene molecules in a mixture can comprise: contacting a mixture comprising different fullerenes with a reagent that reacts at different rates or to a different extent with different types of fullerenes in the mixture and separating the fullerenes based upon the extent of reaction between the fullerene and the reagent. In preferred embodiments, substantially all of at least one type of fullerene is removed.

Alternatively, or in addition, the mixture may comprise a fullerene and one or more contaminants, where at least one contaminant reacts with the reagent at a different rate than the fullerene, thereby permitting separation of the fullerene from the contaminant.

In preferred examples, a mixture of different fullerenes can comprise the soot produced in a Kratschmer-Huffman type reaction or can be the product of a solvent extraction and/or another procedure that substantially separates the mixture of fullerenes from non fullerene components of soot. A mixture of different fullerenes can include two or more fullerenes of formula Cₘ (e.g., C₆₀, C₇₀, C₈₀, C₈₄, and larger cage fullerenes), metallofullerenes with various carbon numbers, and trimetallic nitride endohedral metallofullerenes (e.g. A₃₋ₙXₙN@Cₘ; where A and X represent metals, n=0-3; and m can be typically 80 and/or 84) and may include various contaminants. Preferably, the mixture comprises A₃₋ₙXₙN@Cₘ, where m is 80 and/or 84, and one or more fullerenes and/or metallofullerenes with various carbon numbers.

In preferred examples, the reaction of the reagent with a fullerene comprises formation of a covalent bond or bonds, and in more preferred examples the reaction comprises reversible formation of a covalent bond or bonds. In preferred examples, the reaction of the reagent with a fullerene comprises simultaneous formation of two covalent bonds. For example, the reaction may comprise a Diels-Alder type reaction. In an exemplary embodiment, the reaction comprises a reversible Diels-Alder type cycloaddition reaction. In such an exemplary embodiment, the reagent can comprise a cyclic diene, a cyclic diene derivative, or a substituted cyclic diene comprising one or more substituents. Substituents may preferably be chosen to convey properties to reacted fullerenes that assist in separation. Alternatively, the reagent can comprise a substrate functionalized with a diene containing group such as a cyclodiene, for example cyclopentadiene, cyclohexadiene, a variant comprising a non-carbon atom, a derivative of these comprising one or more substituent groups, and the like.

Separating the reacted material can comprise separation based on solubility, chromatographic separation, and/or physical separation such as where the reagent is attached to a substrate.

In a preferred embodiment, after separation the method further comprises causing the reaction of reagent and fullerene to be reversed. In some embodiments, this permits recovery of reacted fullerene and/or reuse of the reagent.

The foregoing is merely a brief summary and should not be considered limiting in any way. Additional embodiments, variations, and examples are described below.

### BRIEF DESCRIPTION OF THE DRAWINGS

FIG. 1 illustrates building blocks of different fullerenes.

FIG. 2 illustrates a reversible reaction of cyclopentadiene with C₆₀.

FIG. 3 illustrates HPLC chromatograms of a of a mixture of C₆₀ and Sc₃N@C₈₀ reacted with a few drops of freshly prepared cyclopentadiene for 0, 15, 45, and 75 minutes relative to an internal rubrene standard.

FIG. 4 illustrates a scheme in which a cyclohexadiene comprising two carboxymethylester substituents can react with a classical fullerene such as C₆₀ so as to convey water solubility to the C₆₀

FIGS. 5-6 illustrate preparation of thermally stable silica-supported dienes.

FIGS. 7A and 7B illustrate two exemplary methods of preparing cyclopentadiene functionalized silica gel. FIG. 7C illustrates a method of preparing a furan functionalized silica gel.

FIG. 8 shows the relative removal from solution of various types of fullerenes from a mixture of fullerenes using cyclopentadiene and furan functionalized silica gel. From left to right in each group: C60, C70, C84, and trimetallic nitride endohedral fullerene (TMS).

FIG. 9 shows cyclic voltammetry scan rate dependence of Sc₃N@C₈₀ at (A) 20 mV/s and (B) 100 mV/s.

FIG. 10 shows the scan rate dependence of first cathodic peak for Sc₃N@C₈₀.

FIG. 11 shows the scan rate dependence of the second set of cathodic peaks for Sc₃N@C₈₀.

FIG. 12 shows the scan rate dependence of the complete cathodic CV for Sc₃N@C₈₀.

FIG. 13 shows the scan rate dependence of the first anodic peak for Sc₃N@C₈₀.

FIG. 14 shows the scan rate dependence of the second set of anodic peaks for Sc₃N@C₈₀.

FIG. 15 shows the scan rate dependence of the complete anodic CV for Sc₃N@C₈₀.

FIG. 16 illustrates a Diels-Alder derivative of Sc₃N@C₈₀.

FIG. 17 illustrates a reaction scheme for a Prato-type Sc₃N@C₈₀ derivative.

FIG. 18 illustrates electrochemistry of a Diels-Alder derivative of Sc₃N@C₈₀.

FIG. 19 illustrates electrochemistry of a Prato-type Sc₃N@C₈₀ derivative.

FIG. 20 illustrates a cathodic square wave voltammetry comparison of Sc₃N@C₈₀ and derivatives in which the Prato derivative and Diels Alder derivative have three peaks at similar potentials that are distinct from the Sc₃N@C₈₀ peaks. (Top trace: Prato derivative; Middle trace: Diels Alder derivative; Bottom trace: Sc₃N@C₈₀).

FIG. 21 illustrates an anodic square wave voltammetry comparison of Sc₃N@C₈₀ and derivatives in which the Prato derivative and Diels Alder derivative have three peaks at similar potentials which are distinct from the corresponding Sc₃N@C₈₀ peaks. (Trace beginning at about −1.35: Prato; Trace beginning at about −1.7: Diels Alder; Trace beginning at about −0.6: Sc₃N@C₈₀)

FIG. 22 illustrates polyaddition of PFC-cyclopentadiene to C₆₀ to produce fluorocarbon soluble adducts.

### DETAILED DESCRIPTION OF THE PREFERRED EMBODIMENTS OF THE INVENTION

It has been discovered that differences in electronic structure of fullerenes of various types permit separation and purification of different types of fullerenes based on chemical reactivity.

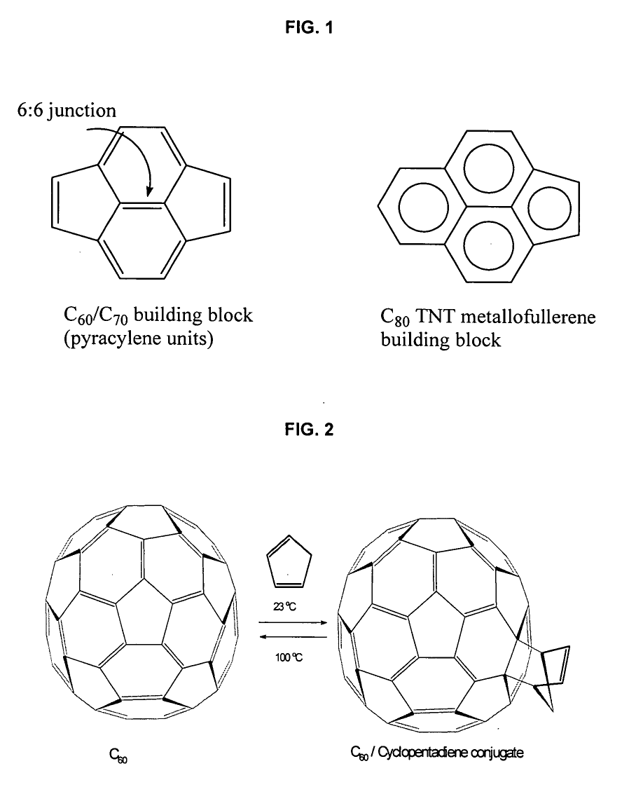

For example, C₆₀ and C₇₀, other fullerenes and various classical metallofullerenes contain a type of 6:6 ring junctions where two six-member rings are joined by two five-member rings. These 6:6 ring junctions form a pyracylene region or Stone-Wales patch, as shown in FIG. 1. (Stone, A. J. and Wales, D. J., Chem. Phys. Lett., 128: 501, 1986). At these 6:6 junctions, the bond shared by the two hexagons (˜1.38 Å) is shorter than the bond at the 6:5 junctions between a hexagon and a pentagon (˜1.45 Å). Consequently, in the lowest energy structure, the fullerene's C═C double bonds are positioned at the 6:6 junction and single bonds are positioned at the 6:5 junction.

The reactivity of C₆₀ is similar to a localized, electron-deficient polyolefin, because of its isolated double bonds. Addition reactions described by A+B=C (such as Diels-Alder reactions) primarily occur at the 6:6 junctions having these localized double bonds. For example, cycloaddition reactions occur preferentially and relatively quickly at the 6:6 junctions of C₆₀ and C₇₀ fullerenes. Additions occur so as to minimize the formation of energetically unfavorable 5:6 double bonds. Under preferable conditions, a substantial degree of control and predictability of such reactions can be achieved.

As a contrasting example, in reactions that favor the pyracylene-type 6:6 junction, trimetallic nitride endohedral metallofullerenes, e.g., A₃₋ₙXₙN@Cₘ fullerenes having m=80, show a tremendously reduced reaction rate relative to C₆₀ and other fullerenes. The cage of A₃₋ₙXₙN@C₈₀ differs significantly from that of other fullerenes. (Olmstead, M. M., et. al. J. Am. Chem. Soc., 122:12220-12226, 2000) The Iₕ (icosahedral) C₈₀ cage lacks the 6:6 junction sites found in C₆₀ and C₇₀. Localized double bonds, which favor Diels-Alder type cycloaddition reactions, do not appear to be present on the C₈₀ cage. Further, the distribution electric charge on the surface of trimetallic nitride endohedral metallofullerenes is also affected by the caged trimetallic nitride group, promoting increased stability and reduced reactivity relative to other fullerenes.

Exploiting the differences in chemical reactivity between different types of fullerenes, a chemical method of separating different types of fullerenes from each other and/or from various contaminants can comprise: contacting a mixture comprising different fullerenes with a reagent that reacts at different rates or to a different extent with different types of fullerene in the mixture and separating at least one type of fullerene from the mixture based upon the extent of reaction between the fullerene and the reagent.

In preferred examples, a mixture of different fullerenes can comprise the soot produced in a Kratschmer-Huffman type reaction or can be the product of a solvent extraction and/or another procedure that substantially separates fullerenes from non fullerene components of soot. A mixture of different fullerenes can include two or more fullerenes of formula Cₘ, such as C₆₀, C₇₀, C₈₀, C₈₄, higher cage fullerenes, metallofullerenes with various carbon numbers, and trimetallic nitride endohedral metallofullerenes (e.g. A₃₋ₙXₙN@Cₘ; where m can be typically 80 and/or 84) and may include various contaminants. Preferably, the mixture comprises A₃₋ₙXₙN@Cₘ, where m is 80 and/or 84, and one or more of C₆₀, C₇₀, and metallofullerenes with various carbon numbers. Alternatively, or in addition, the mixture may comprise a fullerene and one or more contaminants, where at least one contaminant reacts with the reagent at a different rate than the fullerene, thereby permitting separation of the fullerene from the contaminant.

In preferred examples, the reaction of the reagent with a fullerene comprises formation of a covalent bond or bonds, and in more preferred examples the reaction comprises reversible formation of a covalent bond or bonds. In preferred examples, reaction comprises simultaneous formation of two covalent bonds. For example, the reaction may comprise a Diels-Alder type reaction. In a preferred embodiment, the reaction comprises a reversible Diels-Alder type cycloaddition reaction.

Where the reaction is a Diels-Alder type reaction, the reagent can comprise any diene that will convey a property to the fullerenes with which it reacts that can be used to separate those fullerenes from the mixture. As examples, the reagent can comprise cyclopentadiene, a cyclopentadiene derivative, a substituted cyclopentadiene comprising one or more substituents, cyclohexadiene, a cyclohexadiene derivative, a substituted cyclohexadiene comprising one or more substituents, or the like, including molecules such as furan. Alternatively, the reagent can comprise a substrate functionalized with a diene, such as a cyclopentadiene, a cyclopentadiene derivative, a substituted cyclopentadiene comprising one or more substituents, a furan, a cyclohexadiene, a cyclohexadiene derivative, a substituted cyclohexadiene comprising one or more substituents, or the like.

Without limitation, preferred reagents for use in these methods may include structures exemplified by formulas I, II or III where R₁ and R₂ can be the same or different. R₁ and/or R₂ are preferably chosen to convey a property to fullerenes with which the reagent reacts. As an example R₁ and/or R₂ may be —COOCH₃ which can be converted to —COO⁻ following reaction with a mixture of fullerenes to convey solubility in aqueous solution to those fullerenes with which it reacts, or may comprise a perfluorocarbon moiety, which can convey solubility in a perfluorinated hydrocarbon solvent. In various alternatives, R₁ and/or R₂ can convey affinity to a substrate, may cause aggregation of reacted fullerenes, or may link the diene to a substrate such as a silica gel or polymer resin. It should be noted that the arrangement and number of substituent groups need not be as illustrated in the examples, that is, in a substituted cyclopentadiene or hexadiene there may be one or more than one Rᵢ, and the Rᵢ may be bonded to any carbon of the ring.

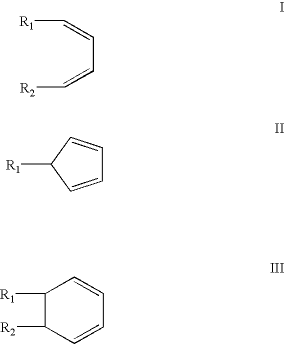

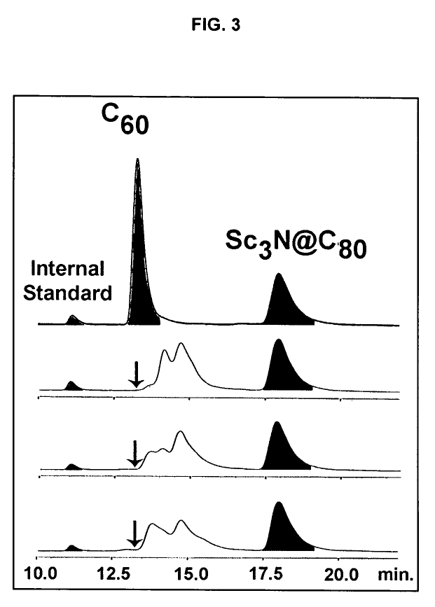

FIG. 2 illustrates a reversible reaction of cyclopentadiene with C₆₀. FIG. 3 illustrates HPLC chromatograms of a mixture of C₆₀ and SC₃N@C₈₀ at 0, 15, 45, and 75 minutes reacted with a few drops of freshly prepared cyclopentadiene added to a N₂-purged 25 mL o-xylene solution containing 4.5 mg of Sc₃N@C₈₀ and 4.7 mg C₆₀. Aliquots were removed at regular time intervals and analyzed by HPLC relative to an internal standard, rubrene. The C₆₀ eluting at about 13 minutes in the top trace, where t=0 is almost entirely converted to the adduct eluting at about 14-15 minutes in the first interval. The area ratios of Sc₃N@C₈₀ to rubrene remained constant at all times.

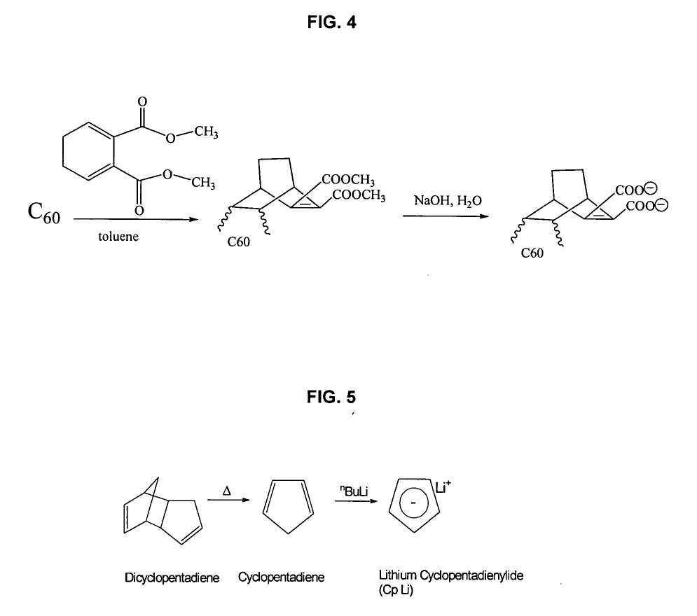

FIG. 4 illustrates a scheme in which a cyclohexadiene comprising two carboxymethylester substituents can react with a classical Cₘ fullerene having pyracylene-type 6:6 junctions such as C₆₀ so as to convey water solubility to the reacted fullerenes, which can be used to separate fullerenes like C₆₀ that react at a high rate and form multiple adducts from A₃₋ₙXₙN@Cₘ, where m=80 and/or 84, which react very little or not at all. In a one-step Diels-Alder reaction, an excess of diene in organic solvent (e.g., toluene) yields a polyadduct of C₆₀, C₇₀, and/or other classical fullerenes present in the mixture. Hydrolysis of the esters produces a water-soluble compound that can be extracted from the organic phase into an aqueous phase, leaving A₃₋ₙXₙN@Cₘ such as A₃₋ₙXₙN@C₈₀ behind. In a preferred separation method, the reaction can be performed directly on an o-xylene solution of mixed fullerenes comprising A₃₋ₙXₙN@C₈₀ prepared by solvent extraction from soot produced in a Kratschmer-Huffman reactor. The cycloaddition reaction can be reversed by application of heat.

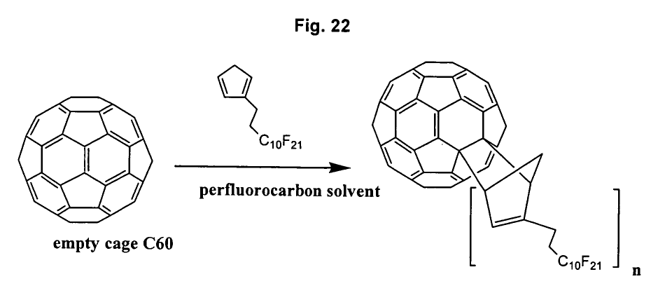

As another example, in a variation of the method utilizing fluorous substituted diene as a reagent, the reaction can be performed in a vessel containing two immiscible solvents such as perfluorocarbon and toluene. Unreacted fullerenes are soluble in toluene. FIG. 22 illustrates formation of a polyadduct of a fluorous substituted diene (PFC-diene) with empty-cage C₆₀ molecules. This reagent preferentially reacts with fullerenes of type Cₘ, such as those having pyracylene-type 6:6 junctions, e.g., fullerenes such as C₆₀, rendering the PFC-polyadducts fluorocarbon soluble and leaving fullerenes of type A₃₋ₙXₙN@Cₘ (e.g. where M is preferably 80 and/or 84), which react at a substantially lower rate or not at all, behind in the toluene solution.

Accordingly, a method of separating different types of fullerenes from each other and/or from various contaminants can comprise: contacting a mixture comprising different types of fullerene with a reagent that reacts at different rates or to a different extent with different types of fullerene in the mixture where the reagent conveys a property to a fullerene with which it reacts that can be used to separate reacted from unreacted fullerene. The method can further comprise separating the fullerenes based upon the extent of reaction between each type of fullerene and the reagent. In a simple example, the reagent conveys a change in solubility upon those types of fullerene that react with the reagent and the types of fullerene can be separated using phase extraction. In alternative methods, the reagent reacts to a different extent with different types of fullerene, for example as a function of the number of pyracyclene units, and the types of fullerene can be separated based upon the extent of reaction, e.g. the number of adduct groups per fullerene.

The methods described herein can further comprise preparing a mixture of fullerenes from soot produced in a in a Kratschmer-Huffman reactor by solvent extraction. For example, a mixture of fullerenes produced in the Kratschmer-Huffman reaction can be extracted in o-xylene prior to contacting the mixture with a reagent. The methods may further comprise one or more additional purification steps, such as a chromatographic separation before or after contacting the mixture with a reagent and separating at least one type of fullerene based on the extent of reaction with the reagent.

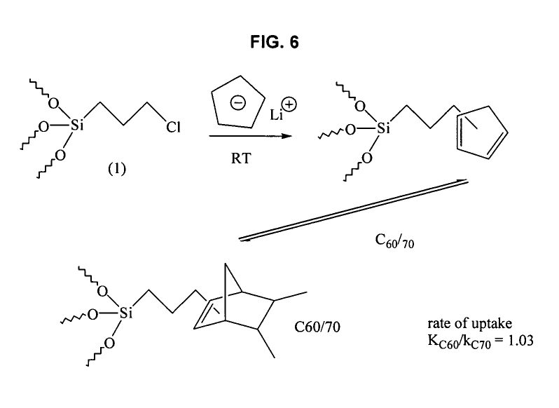

Attachment of fullerenes to solid substrates comprises an alternative approach to chemical separation of classical Cₘ fullerenes such as C₆₀ and higher carbon number empty-cage and metallofullerenes from A₃₋ₙXₙN@Cₘ. Classical fullerenes such as C₆₀ and C₇₀ can react with polymer-supported dienes. These addition reactions occur at room temperature and are reversible. Thermally stable silica-supported dienes prepared as in FIGS. 5-6 react rapidly with C₆₀, C₇₀ and higher carbon number empty-cage fullerenes and classical metallofullerenes. The rate of uptake is efficient. Fullerene that reacts with such a reagent can be physically removed from mixture. For example, the fullerene-containing silica gel can be filtered out of solution to leave a toluene solution containing A₃₋ₙXₙN@Cₘ. The reaction is reversible by application of heat, permitting recovery of reacted fullerenes and/or reuse of the reagent.

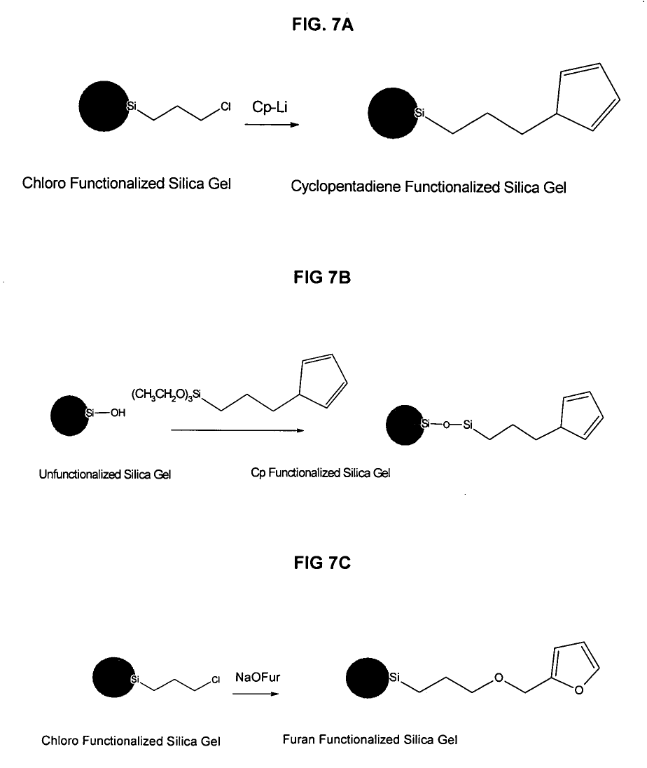

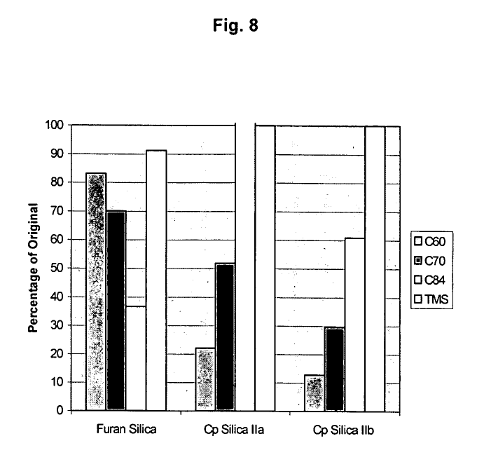

FIGS. 7A and 7B illustrate two exemplary methods of preparing cyclopentadiene functionalized silica gel. FIG. 7C illustrates a method of preparing a furan functionalized silica gel. FIG. 8 shows the relative removal from solution of various fullerenes from a mixture using cyclopentadiene and furan functionalized silica gel. In the figure, TMS refers to trimetaspheres of type Gd₃N@C₈₀. Cyclopentadiene functionalized silica was prepared as illustrated in FIG. 7B using dried silica (Cp Silica IIa) or undried silica (Cp Silica IIb) which produced about 0.22 mmol/g and 0.54 mmol/g cyclopentadiene content respectively. Of course any suitable substrate that can be functionalized can be used, for example acrylic or polyvinyl polymer resins.

Accordingly, a method of separating different types of fullerenes from each other and/or from various contaminants can comprise: contacting a mixture comprising different fullerenes with a functionalized substrate that reacts at different rates or to a different extent with different types of fullerenes in the mixture such that the reacted fullerene is physically removed from the solution. Such a reaction can be conducted in a batch vessel or in a continuous flow vessel. In a continuous flow vessel the mixture may be flowed through a bed of functionalized substrate or contacted in a continuous countercurrent arrangement.

As has been illustrated, separating the reacted material can comprise separation based on solubility, and/or physical separation such as where the reagent is attached to a substrate. In various embodiments, other separation techniques may be utilized, such as any affinity and chromatographic separation methods that may be facilitated by selection of an appropriate substrate. In preferred embodiments, substantially all of at least one type of fullerene is removed from the mixture.

In preferred embodiments, after separation the method further comprises causing the reaction of reagent and fullerene to be reversed. In some embodiments, this permits recovery of reacted fullerene and/or reuse of the reagent.

As a way of illustrating methods of removing one or more types of fullerene from a mixture of fullerene molecule, the foregoing examples illustrate the use of Diels-Alder type reactions that occur at a faster rate to C₆₀ over C₈₀ fullerenes and which do not occur to any significant extent to trimetallic nitride endohedral metallofullerenes such as A₃₋ₙXₙN@C₈₀. To illustrate an alternative approach, a reagent may be chosen that reacts at a higher rate with fullerenes of type A₃₋ₙXₙN@Cₘ than other types of fullerenes. One such reagent can be a redox reagent or electrons having an appropriate potential which can selectively react with fullerenes of type A₃₋ₙXₙN@Cₘ, preferably permitting separation of fullerenes of type A₃₋ₙXₙN@Cₘ from a mixture while leaving empty-cage fullerenes.

It has been discovered that, while photo-induced energy and electron transfer for trinitiride endohedral metallofullerenes (e.g., of formula A₃₋ₙXₙN@Cₘ) are similar to that for the empty cage fullerenes, the energies are different enough to allow selective electrochemical and photochemical reactions.

Without wishing to be bond by theory, the following theoretical and experimental discussion may help explain and illustrate the physical basis underlying this discovery. The low-lying empty orbitals of C₆₀ lead to high electron affinity and a particularly long-lived triplet excited state as well as ready participation as the acceptor component in donor-acceptor dyads. An electron affinity of about 2.60-2.80 eV for C₆₀ has been estimated from photoelectron spectra. Moreover, C₆₀ can accept up to six electrons, giving rise to the ions C₆₀⁻ⁿ (n=1-6). The vertical electron affinity for C₆₀ was computed to be 2.85 eV, a value that is in excellent agreement with the experimental data. The empty cage C₈₀ molecule of Ih symmetry has an even larger vertical electron affinity of 3.75 eV. By comparison, A₃₋ₙXₙN@Cₘ undergoes modification of its electron affinity due to electron acceptance from the captured trimetallic structure. For example, Sc₃N@C₈₀ undergoes modification of the highest occupied molecular orbitals (HOMO)/lowest unoccupied molecular orbitals (LUMO) due to the formal transfer of six electrons from the Sc₃N unit to the cage, which reduces the electron affinity of this compound to 2.99 eV, comparable to the measured value of 2.81 eV. Theoretical electron acceptance values for several nanocompounds are shown in Table 1.

TABLE 1
Computed vertical ionization potentials (IP) and Electron Affinities
(EA) for several optimized molecules (in eV)

| Molecule | Sym | IP | EA | E(HOMO) | E(LUMO) |
|---|---|---|---|---|---|
| Sc₃N | C₃ᵥ | 5.05 | 1.27 | −3.21 | −2.92 |
| C₆₀ | Iₕ | 2.85 | 2.85 | −6.25 | −4.59 |
| C₈₀ | Iₕ | 6.92 | 3.75 | −5.55 | −3.32 |
| Sc₃N@C₈₀ | Cₛ | 6.88 | 2.99 | −5.79 | −4.61 |

Based on the difference in the first oxidation potential between empty C₆₀ and the Ih and D5h isomers of Sc3N@C80 (about 300 mV), it is possible, in an exemplary preferred method, to extract the Ih only Sc3N@C₈₀. In preferred embodiments, the reaction can be accomplished by electrochemical means or by using redox reagent such as a chemical oxidant.

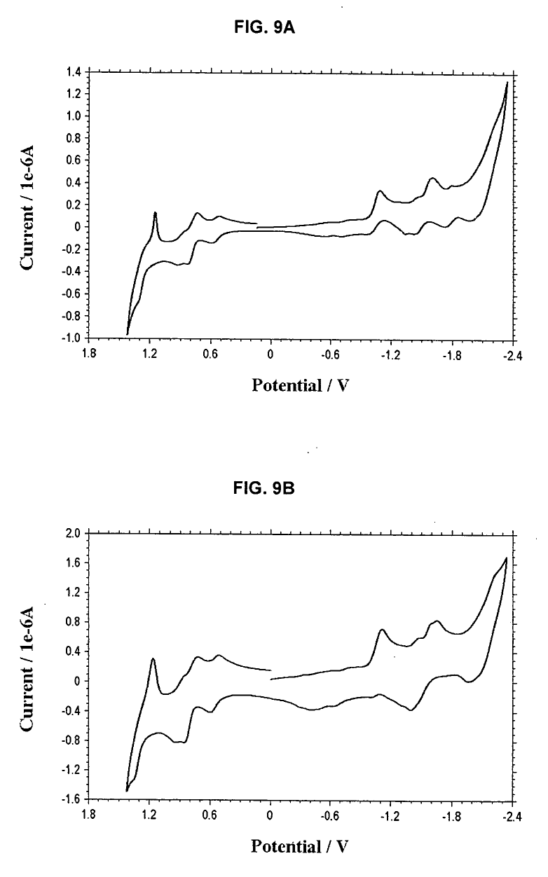

Electrochemical studies have been carried out on various fullerenes of type A₃₋ₙXₙN@Cₘ. The cyclic voltammogram of Sc₃N@C₈₀ illustrated in FIG. 9 shows irreversible electrochemical behavior that is considerably dependent upon scan rate. Many features of the electrochemistry suggest that chemical “reactions” are occurring inside the C₈₀ cage. The first cathodic peak becomes more electrochemically reversible as the scan rate is increased, and the scan rate dependence suggests an electrochemical type mechanism. The first anodic peak of Sc₃N@C₈₀ appears to be a well-behaved electrochemically reversible peak. The cyclic voltammagrams at different scan rates of the next pair of anodic peaks have quite different behaviors. Both the cathodic and anodic sides of the cyclic voltammograms of Sc₃N@C₈₀ suggest very interesting electrochemical behavior—perhaps the first examples of chemical reactions occurring inside a fullerene induced by redox processes. This fact is critical as the electrochemical redox properties are directly related to photo-induced electron transfer and thereby are an indicator of what happens when light is absorbed, for example, through photovoltaic effects.

As an example, soot containing Sc₃N@C₈₀ obtained from Luna Innovations was pre-purified by recrystallization from hot o-xylene. 1.0 mg of the resulting mixture of fullerenes Sc₃N@C₈₀ was dissolved in 1.0 mL of dry 0.05 M TBAPF₆ (tetrabutylammonium hexafluorophosphate) solution in o-dichlorobenzene. A platinum working electrode (1 mm), platinum wire counter electrode, and an Ag/Ag⁺ reference electrode in an 0.1 M TBAPF₆/0.01 M AgNO₃ CH₃CN solution was used to examine the electrochemical properties of Sc₃N@C₈₀.

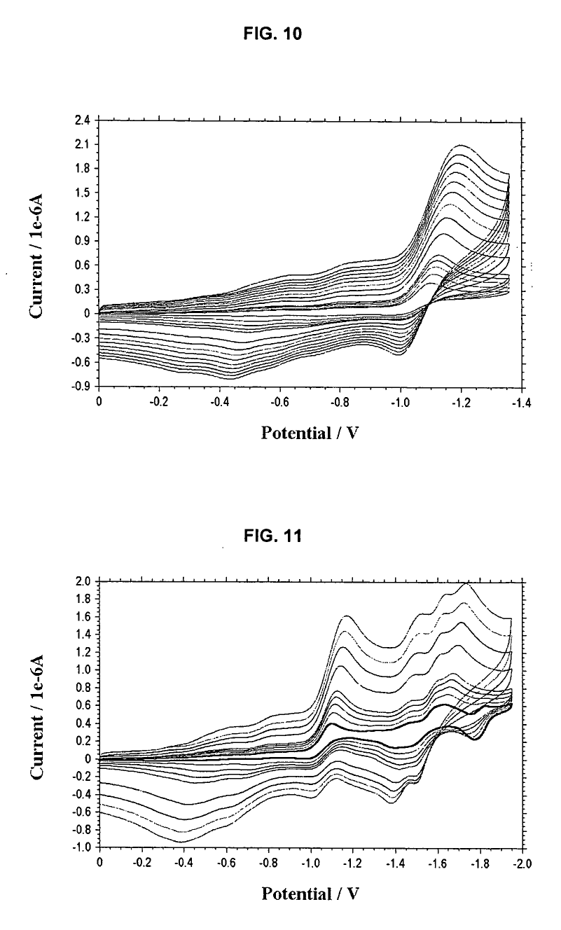

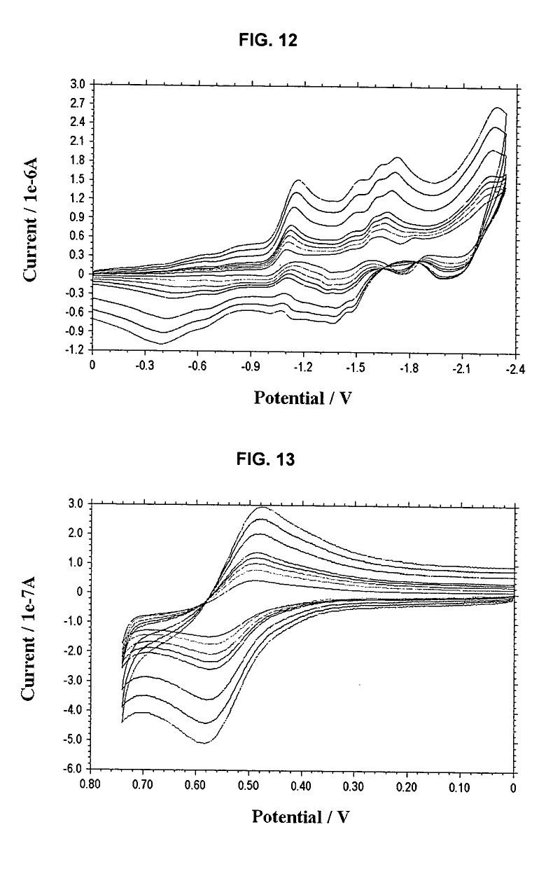

The cyclic voltammogram of Sc₃N@C₈₀ illustrated in FIG. 9 shows irreversible electrochemical behavior that is considerably dependent upon scan rate. Many features of the electrochemistry suggest that chemical “reactions” are occurring inside the C₈₀ cage. The first cathodic peak becomes more electrochemically reversible as the scan rate is increased, and the scan rate dependence suggests an electrochemical mechanism (A⁻→B⁻). (FIG. 10) At faster scan rates, the yield of product B is not as complete because of a slow reaction. In addition, on the return scans, a peak at approximately −0.4 V grows, which suggests the oxidation of B⁻. When the CV is scanned past the next series of cathodic peaks, the slowest scan rate shows a peak at −1.8 V which disappears with faster scan rates. (FIG. 11) This feature suggests the formation of another product through a second electrochemical mechanism: B⁻→C⁻. The return scans show a dramatic intensity increase in the return peak at −0.4 V. Scanning the CV through the final cathodic peak (FIG. 12) further supports the electrochemical mechanism elucidated above.

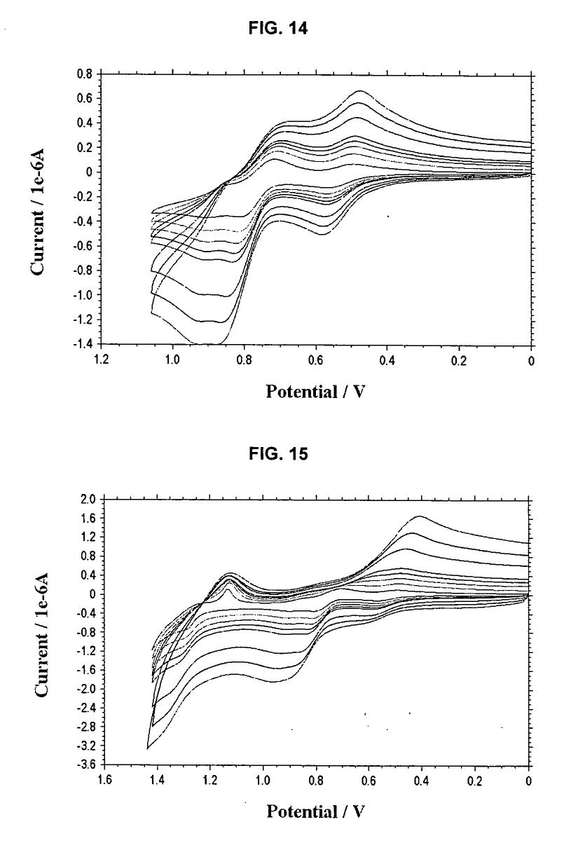

The first anodic peak of Sc₃N@C₈₀ appears to be a well-behaved electrochemically reversible peak. (FIG. 13). The cyclic voltammagrams at different scan rates of the next pair of anodic peaks are shown in FIG. 14. The intensity of the first anodic peak grows and shifts more negative on the return scan. The complete anodic CV is shown in FIG. 15. The final anodic return peak has surface-like behavior that disappears with faster scan rates. Also occurring at fast scan rates is the disappearance of the second set of anodic peaks on the return scan, with a dramatic intensity increase and negative shift of the first anodic peak. The anodic side of the CV indicates at least one electrochemical reaction.

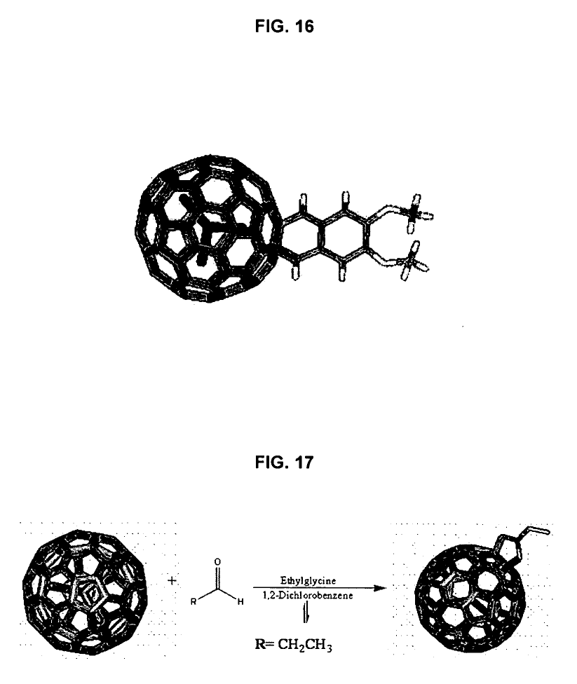

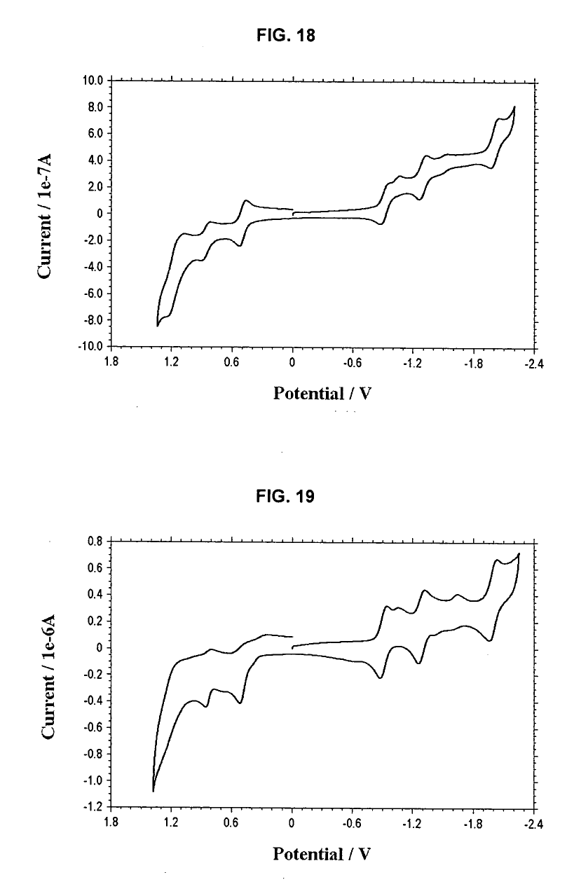

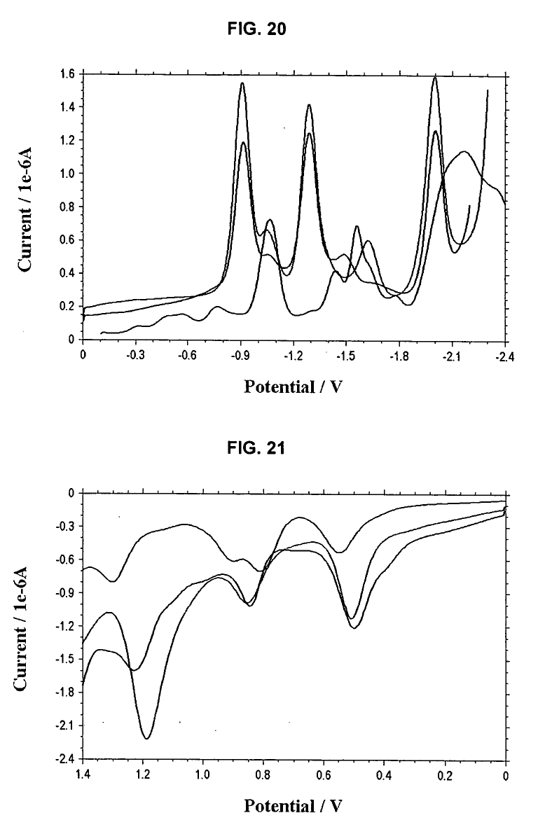

A Diels Alder-SC₃N@C₈₀ derivative was prepared as described by E. B. Lezzi et al., J. Am. Chem. Soc., 2002, 124, 524. The derivative is shown in FIG. 16. In addition, a pyrrolidine derivative was prepared using a synthesis similar to the Prato reaction on C₆₀. (FIG. 17). In the following example, the electrochemical experimental setup for both derivatives was the same as used for Sc₃N@C₈₀. However, the electrochemical behavior of these derivatives was significantly different from that of the parent compound. Both the Diels Alder (FIG. 16) and the Prato derivatives (FIG. 17) showed three electrochemically reversible cathodic peaks (along with several small peaks) in their cyclic voltammograms. While the first anodic peak for the Diels Alder derivative was reversible, the anodic side of the CV for the Prato derivative showed electrochemically irreversible behavior. In addition to the significant difference in the reversibility of the cyclic voltammetry between pristine Sc₃N@C₈₀ and the derivatives, square wave voltammetry illustrates a considerable positive shift in the cathodic peak potentials of the derivatives (FIG. 18). Surprisingly, all three reversible cathodic peaks for both derivatives exactly coincide. The first small peak in both derivatives' voltammograms seems to coincide with the first cathodic peak of Sc₃N@C₈₀. The anodic square wave voltammograms of the parent compound and the derivatives show that, although the derivatives' anodic peaks do not coincide as their cathodic peaks do, there is a negative shift in their potentials compared with Sc₃N@C₈₀ (FIG. 19). Both derivatives show a decreased HOMO-LUMO gap and similar reversible electrochemical behavior.

As illustrated, fullerenes of various types can be subjected to electrochemical reactions or redox reactions which occur at different rates or to a different extent depending on the type of fullerene. Thus, a method of separating one or more types of fullerenes from a mixture of different types of fullerenes can comprise contacting the mixture of fullerenes with a reagent that reacts with one or more types of fullerene in the mixture at a different rates or to a different extent than one or more other types of fullerene in the mixture and separating one or more types of fullerene on the basis of whether or to what extent the fullerenes have reacted with the reagent. In preferred embodiments, the reagent can be a charged moiety, such as an electron, or a chemical redox reagent, for example a chemical reducing agent or a chemical oxidation agent. Alternatively, or in addition to the modes of separation that have been described above, separating reacted fullerenes may include separation on the basis of redox state or ionization, for example by electrochemical means, affinity to an electrode, differences in solubility of charged species, and the like.

For example, a method can comprise contacting a mixture of fullerenes with electrodes at a potential selected to preferentially change the redox state of one or more types of fullerenes, such as fullerenes of type A₃₋ₙXₙN@Cₘ. Fullerenes of a type preferentially oxidized or reduced at the selected potential can be separated based upon ionization. As another example, a method can comprise contacting a mixture of fullerenes with a chemical redox reagent, such as a chemical oxidizer, having an appropriate redox potential to preferentially oxidize or reduce one or more type of fullerene. In preferred embodiments, differences in ionization potential and electron affinity of types of fullerenes can be exploited to choose a potential where fullerene of type A₃₋ₙXₙN@Cₘ is reacted but fullerene of type Cₘ is not reacted. In other preferred embodiments, a potential is chosen where a fullerene of type X₃N@C₈₀ of Ih symmetry reacts but X₃N@C₈₀ and X₃N@C₇₈ of D5 symmetry do not react. In preferred embodiments, the reaction is an electrochemical oxidation reaction, or a chemical oxidation reaction. In preferred embodiments, the reaction may be reversed after separation.

As used herein the word “or” between two things includes a combination of the things, the word “and” includes the alternative, and singular terms include the plural unless the context in which these words are used indicates otherwise. A reversible reaction is understood to be a reaction that can be reversed by application of conditions such as heat, light, pH, reagents, and the like, which results in substantially restoring at least one of the starting materials of the reversible reaction to its state before the reversible reaction or a functionally similar state. For example, a reaction is reversible if a covalent bond or bonds formed in the reaction can by broken by application of an amount of heat that does not destroy the restored starting material. That a reagent has a reaction rate with a material includes the case of no reaction or substantially no reaction unless otherwise indicated. Separating a component of a mixture from the mixture includes any process wherein a substantial majority of the component is removed from the mixture. Separating substantially all of a component from a mixture means that more than about 90%, and preferably more than 95% of the component is removed from a mixture.

While the invention has been described in detail with reference to preferred embodiments thereof, it will be apparent to one skilled in the art that various changes can be made, and equivalents employed, without departing from the scope of the invention.

What is claimed is:

1. A method comprising:
contacting a mixture comprising different types of fullerene with a reagent that reacts at different rates or to a different extent with the different types of fullerene in the mixture; and,
separating at least one type of fullerene from the mixture based upon the extent of reaction between the type fullerene separated and the reagent.

2. The method of claim 1, wherein substantially all of at least one type of fullerene is removed.

3. The method of claim 1, wherein the mixture comprises a fullerene and one or more contaminants, and wherein at least one contaminant reacts with the reagent at a different rate than the fullerene, thereby permitting separation of the fullerene from the contaminant.

4. The method of claim 1, wherein the mixture of different fullerenes comprises soot produced in a Kratschmer-Huffman type reaction.

5. The method of claim 1, wherein the mixture comprises a product of a procedure that substantially separates fullerene from non-fullerene components of soot produced in a Kratschmer-Huffman type reaction.

6. The method of claim 1, wherein the mixture comprises A₃₋ₙXₙN@Cₘ, where A and X are metals, n is from 1 to 3, and m is 80 and/or 84, and one or more empty-cage fullerene or other type of metallofullerene.

7. The method of claim 1, wherein the reaction of the reagent with a fullerene comprises a Diels-Alder type reaction.

8. The method of claim 1, wherein the reagent comprises a carbon-carbon single bond between a pair of carbon-carbon double bonds.

9. The method of claim 1, wherein the reagent comprises a cyclic diene, a cyclic diene derivative, or a substituted cyclic diene comprising one or more substituents.

10. The method of claim 9, wherein the reagent comprises a cyclopentadiene group.

11. The method of claim 9, wherein the reagent comprises a cyclohexadiene group.

12. The method of claim 1, wherein the reagent comprises a diene functional group chemically linked to a substrate.

13. The method of claim 12, wherein the reagent comprises a cyclic diene functional group chemically linked to silica gel.

14. The method of claim 12, wherein contacting the reagent with the mixture of fullerenes is performed in a continuous flow apparatus comprising a bed of reagent.

15. The method of claim 12, wherein contacting the reagent with the mixture of fullerenes is performed in a continuous flow apparatus comprising a countercurrent flow of reagent.

16. The method of claim 1, wherein separating the reacted material comprises separation based on solubility or chromatographic separation.

17. The method of claim 1, wherein the reaction of reagent and at least one type of fullerene is reversible, the method further comprising treating separated reacted fullerene to reverse the reaction, and recovering one or both of the reagent and separated fullerene.

18. The method of claim 1, wherein the reagent comprises an electrode.

19. The method of claim 1, wherein the reagent comprises a chemical redox reagent.

20. The method of claim 19, where the reagent comprises a chemical oxidizer.

21. The method of claim 19, wherein the reagent comprises a chemical reducing agent.

22. A method comprising:
contacting a mixture comprising different fullerenes with a reagent in solution that reacts at different rates or to a different extent with different types of fullerenes in the mixture; and,
separating at least one type of fullerene from the mixture based upon the extent of reaction between the type fullerene separated and the reagent.

23. A method comprising:
contacting a mixture comprising different fullerenes with a functionalized substrate that reacts at different rates or to a different extent with different types of fullerenes in the mixture whereby reacted fullerene is covalently bound to the substrate.

24. A method comprising:
contacting a mixture comprising different fullerenes with an electrochemical potential chosen so as to cause substantially all of at least one type of fullerene in the mixture to be oxidized or reduced wherein another type of fullerene in the mixture is substantially unchanged; and,
removing the reacted fullerene from the mixture.
